(19) United States
(12) Patent Application Publication
(10) Pub. No.: US 2013/0083446 A1
(43) Pub. Date: Apr. 4, 2013

(54) Ion Wind Generator, Ion Wind Generating Apparatus, and Ion Wind Generating Method

(71) Applicants: Takashige Yagi, Kagoshima (JP); Tetsuya Tojo, Kagoshima (JP); Hiroshi Makino, Kagoshima (JP)

(72) Inventors: Takashige Yagi, Kagoshima (JP); Tetsuya Tojo, Kagoshima (JP); Hiroshi Makino, Kagoshima (JP)

(73) Assignee: KYOCERA CORPORATION, Kyoto-shi, Kyoto (JP)

(21) Appl. No.: 13/638,540

(22) PCT Filed: Mar. 17, 2011
(86) PCT No.: PCT/JP2011/056393

§ 371 Date: Oct. 24, 2012

(30) Foreign Application Priority Data
Jun. 22, 2010 (JP) 2010-141933

(51) Int. Cl. H01T 23/00

(52) U.S. Cl. CPC H01T 23/00
USPC 361/231

(57) ABSTRACT

Provided is an ion wind generator which is able to raise the speed of the ion wind. An ion wind generator (3) has: a first electrode (9) and a second electrode (11) which are supplied with voltage and induce an ion wind by electric discharge, and a third electrode (13) which forms an electric field for accelerating the ion wind in a downstream region of the ion wind relative to the first electrode (9) and the second electrode (11).

### TECHNICAL FIELD

The present invention relates to an ion wind generator, an ion wind generating apparatus, and an ion wind generating method.

### BACKGROUND ART

Known in the art is an apparatus which generates an ion wind which is induced by movement of electrons or ions. For example, in Patent Literature 1, AC voltage is applied to two electrodes which are separated by a dielectric to generate a dielectric barrier discharge and thereby generate an ion wind. Further, in Patent Literature 1, as a method for utilizing ion wind, generating an ion wind so as flow along the surface of wings etc. so as to suppress peeling of a boundary layer and so on may be mentioned.

### CITATIONS LIST

### Patent Literature

Patent Literature 1: Japanese Patent Publication No. 2007-317656 A1

### SUMMARY OF THE INVENTION

### Technical Problem

The art of generating ion wind is now in the development stage. Various problems and demands exist concerning this art For example, it is desired to enable greater speed of the ion wind. Note that, in the art of Patent Literature 1, in order to raise the speed of the ion wind, it is necessary to apply a high voltage to the electrodes which induce the ion wind, so the power consumption cannot help but be increased.

### Solution to the Problem

An ion wind generator of a first aspect of the present invention has a first electrode and a second electrode which are supplied with voltage and induce an ion wind by electric discharge and has a field forming member which forms an electric field for accelerating the ion wind in a downstream region of the ion wind relative to the first electrode and the second electrode.

An ion wind generating apparatus of a second aspect of the present invention has a first electrode, a second electrode, a first power supply which supplies voltage to the first electrode and the second electrode and makes the first electrode and the second electrode induce an ion wind by electric discharge, and a field forming part which forms an electric field for accelerating the ion wind in the downstream region of the ion wind relative to the first electrode and the second electrode.

An ion wind generating method of a third aspect of the present invention has a step of supplying voltage to the first electrode and second electrode and inducing an ion wind by electric discharge and a step of forming an electric field in the downstream region of the ion wind relative to the first electrode and the second electrode and accelerating the ion wind.

### Advantageous Effects of the Invention

According to the above configurations or procedure, the speed of the ion wind can be raised.

### BRIEF DESCRIPTION OF THE DRAWINGS

FIG. 1 is a perspective view schematically showing an ion wind generating apparatus according to a first embodiment of the present invention.

FIG. 2 is a view for explaining a mode of operation of the ion wind generating apparatus in FIG. 1.

FIG. 3 is a perspective view schematically showing principal parts of an ion wind generating apparatus of a second embodiment.

FIG. 4 is a perspective view schematically showing principal parts of an ion wind generating apparatus of a third embodiment.

FIG. 5 is a perspective view schematically showing principal parts of an ion wind generating apparatus of a fourth embodiment.

FIG. 6 is a perspective view schematically showing principal parts of an ion wind generating apparatus of a fifth embodiment.

FIG. 7 is a perspective view schematically showing principal parts of an ion wind generating apparatus of a sixth embodiment.

FIG. 8 is a perspective view schematically showing principal parts of an ion wind generating apparatus of a seventh embodiment.

FIG. 9 is a perspective view schematically showing principal parts of an ion wind generating apparatus of an eighth embodiment.

FIG. 10 is a perspective view schematically showing principal parts of an ion wind generating apparatus of a ninth embodiment.

### DESCRIPTION OF EMBODIMENTS

Below, an ion wind generator, ion wind generating apparatus, and ion wind generating method according to a plurality of embodiments of the present invention will be explained with reference to the drawings. Note that, the drawings used in the following explanation are schematic ones. Dimensional ratios etc. on the drawings do not necessarily match with the actual ones.

Further, in the second and following embodiments, for the configurations common or similar to those in the already explained embodiments, notations common to those in the already explained embodiments will be used, and illustrations and explanations will be sometimes omitted.

### First Embodiment

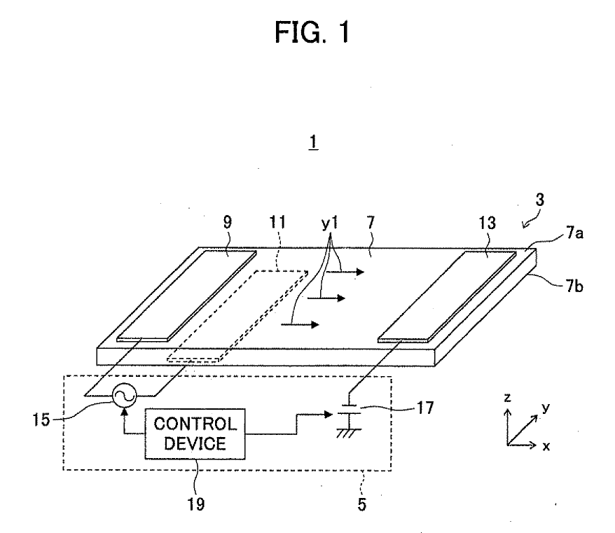

FIG. 1 is a perspective view schematically showing an ion wind generating apparatus 1 according to a first embodiment of the present invention.

The ion wind generating apparatus 1 is configured as an apparatus which generates an ion wind which flows in a direction which is indicated by an arrow y1. Note that, in the present embodiment, sometimes, the direction of flow of the ion wind will be referred to as an “x-direction”, a width direction of the ion wind will be referred to as a “y-direction”, and a height direction of the ion wind will be referred to as a “z-direction”.

The ion wind generating apparatus 1 has an ion wind generator 3 for generating an ion wind and a drive part 5 which drives and controls the ion wind generator 3.

The ion wind generator 3 has a dielectric 7 and has a first electrode 9, a second electrode 11, and a third electrode 13 which are disposed on the dielectric 7.

The dielectric 7 is for example formed in a flat plate shape having a constant thickness and has a first major surface 7a and a second major surface 7b which is the back surface of the former. Note that, as indicated by the arrow y1, the ion wind flows above the first major surface 7a along the first major surface 7a. The planar shape of the dielectric may be made a suitable shape. However, FIG. 1 illustrates a case where a rectangle having sides parallel in the x-direction and in the y-direction is given.

The dielectric may be formed by an inorganic insulating material or may be formed by an organic insulating material. As the inorganic insulating material, for example, ceramic, glass, etc. can be mentioned. As the ceramic, for example, an aluminum oxide sintered body (alumina ceramic), glass ceramic sintered body (glass ceramic), mullite sintered body, aluminum nitride sintered body, cordierite sintered body, silicon carbide sintered body, and so on can be mentioned. As the organic insulating material, for example, there can be mentioned a polyimide, epoxy, and rubber.

The dielectric 7 is formed for example by a ceramic green sheet laminating method in a case where it is formed by an aluminum oxide sintered body. The ceramic green sheet is formed by adding and mixing with base powder such as alumina (Al₂O₃), silica (SiO₂), calcia (CaO), magnesia, or the like a suitable organic solution and solvent to prepare a slurry and forming this into a sheet shape by shaping method such as doctor blade method, calendar roll method, or the like.

The first electrode 9 is disposed on the first major surface 7a, and the second electrode 11 is disposed on the second major surface 7b. Due to this, the first electrode 9 and the second electrode 11 are separated (insulated) by the dielectric 7.

The second electrode 11 has a portion (the entire second electrode 11 in the present embodiment) located on the downstream side of the ion wind (on one side in the direction (x-direction) along the first major surface 7a (predetermined surface) of the dielectric 7) relative to the first electrode 9. Note that, when viewing the first major surface 7a of the dielectric 7 on a plane, in the x-direction, the first electrode 9 and the second electrode 11 may partially overlap, may be adjacent without a gap, or may be separated by a predetermined clearance.

A third electrode 13 is disposed on the first major surface 7a. That is, it is disposed on the same plane as the first electrode 9. The third electrode 13 is arranged on the side opposite to the first electrode 9 (on downstream side of the ion wind) relative to the second electrode 11 with a space.

The first electrode 9, second electrode 11, and third electrode 13 are for example formed in layer shapes (including flat plate shapes) having constant thicknesses. The planar shapes of these electrodes may be suitable ones. In FIG. 1, however, a case where they are given rectangular shapes each having sides which are parallel in the x-direction and in the y-direction is exemplified. Note that, the lengths in the y-direction of these electrodes are for example set the same as each other.

The first electrode 9, second electrode 11, and third electrode 13 are formed by a conductive material such as a metal or the like. These electrodes may be formed by a suitable thin film forming method and patterning method or may be formed by printing a conductive paste. Further, these electrodes may also be provided by having a metal sheet joined to the dielectric 7 by an organic resin-based binder, glass, or metal.

As the above metal, tungsten, molybdenum, manganese, copper, silver, gold, palladium, platinum, nickel, cobalt, or alloys containing them as the principal ingredients can be mentioned.

The conductive paste is prepared for example by adding an organic solvent and an organic binder to metal powder of tungsten, molybdenum, copper, silver, or the like and mixing them. In the conductive paste, according to need, a dispersant, a plasticizer, etc. may be added as well. Mixing is carried out by for example a ball mill, triple roll mill or planetary mixer or other kneading means.

By printing this conductive paste at predetermined positions on the ceramic green sheet which will become the dielectric 7 by using the screen printing method or other printing means and simultaneously firing it, the first electrode 9, second electrode 11, and third electrode 13 can be formed.

Note that, in the conductive paste, when fired simultaneously with the ceramic green sheet, a powder of glass or ceramic may be added for matching with the sintering behavior of the ceramic green sheet or raising the bonding strength with the dielectric after sintering by mitigating the residual stress.

Note that the dimensions and materials of the first electrode 9, second electrode 11, and third electrode 13 may be the same as each other or different from each other.

The drive part 5 has an AC power supply device 15 which supplies AC voltage to the first electrode 9 and the second electrode 11, a DC power supply device 17 which supplies a DC voltage to the third electrode 13, and a control device 19 which controls the AC power supply device 15 and DC power supply device 17.

The AC voltage which is supplied by the AC power supply device 15 may be a voltage which is represented by a sine wave etc. and continuously changes in potential or may be a voltage in a pulse-state which discontinuously changes in potential. Further, the AC voltage may be a voltage which fluctuates in potential in both of the first electrode 9 and the second electrode 11 or may be a voltage which fluctuates in potential relative to the reference potential in only one of the first electrode 9 and second electrode 11 since the other is connected to the reference potential. The potential may fluctuate to both the positive and negative relative to the reference potential or may fluctuate to only one of the positive or negative relative to the reference potential.

The DC power supply device 17 supplies a DC voltage to the third electrode 13 in a state where a closed loop is not configured. That is, to the third electrode 13, only a positive terminal or negative terminal of the DC power supply device 17 is connected, so a closed loop in which the current from the DC power supply device 17 flows is not configured.

The control device 19 for example controls the ON/OFF state of supply of voltages by the AC power supply device 15 and the DC power supply device 17 or magnitudes of voltages which are supplied and so on according to a predetermined sequence or operation by the user.

Note that the dimensions of the dielectric 7, first electrode 9, second electrode 11, and third electrode 13, the magnitude and frequency of the AC voltage, and the magnitude of the DC voltage may be suitably set in accordance with the art to which the ion wind generating apparatus 1 is applied or the required nature of the ion wind and other various types of situations.

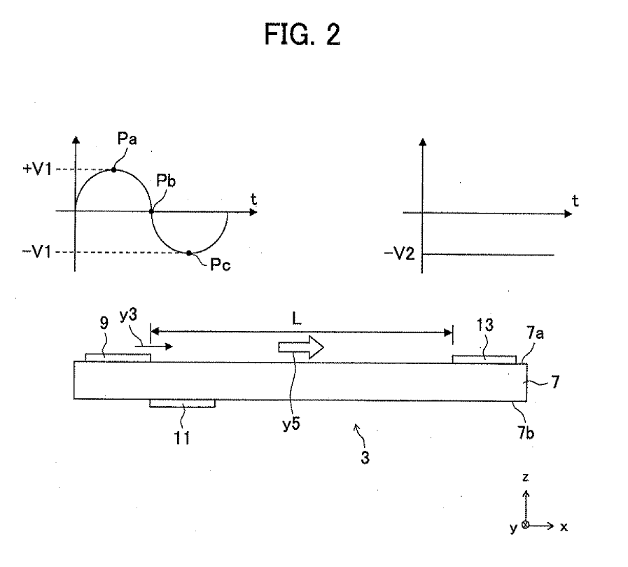

FIG. 2 is a view including a side view of the ion wind generator 3 for explaining the mode of operation of the ion wind generating apparatus 1. The top left graph in FIG. 2 shows the change of the potential of the first electrode 9. The top right graph in FIG. 2 shows the change of the potential of the third electrode 13. In these graphs, the abscissas show times “t”, and the ordinates show potentials.

Note that, FIG. 2 exemplifies a case where the potential of the first electrode 9 fluctuates to both the positive and negative relative to the reference potential, and a negative potential is given to the third electrode 13. In the example of FIG. 2, the second electrode 11 may be given a potential reverse to that for the first electrode 9 or may be given the reference potential.

The ion wind generator 3 is placed in the atmosphere. Air is present around the ion wind generator 3. Note that, the ion wind generator 3 may be placed and used in a specific type of gaseous atmosphere (for example under a nitrogen atmosphere).

When a voltage is supplied between the first electrode 9 and the second electrode 11 by the AC power supply device 15, and a potential difference between these electrodes exceeds the predetermined threshold value, plasma is generated along with electric discharge. Note that, the first electrode 9 and the second electrode 11 are separated by the dielectric 7, therefore the electric discharge is a dielectric barrier discharge.

Electrons or ions in plasma move by the electric field formed by the first electrode 9 and the second electrode 11. Further, neutral molecules move accompanied with electrons or ions. Ion wind is induced in this way.

More specifically, the ion wind is, as indicated by an arrow y3, induced by electrons or ions moving from the first electrode 9 side to the second electrode 11 side centered around a region on the first major surface 7a which overlaps the second electrode 11 and flows from the first electrode 9 side to the second electrode 11 side.

Note that, as exemplified in the top left graph in FIG. 2, when the potential of the first electrode 9 fluctuates to both of the positive and negative relative to the reference potential, i.e., in other words, the potential of the first electrode 9 fluctuates to both the positive and negative relative to the potential of the second electrode 11, the direction of the electric field formed by the first electrode 9 and second electrode 11 reverses as well. Accordingly, the positive and negative states of charges which move in the direction from the first electrode 9 side to the second electrode 11 side as indicated by the arrow y3 reverse as well.

Further, although it is not particularly shown, when the potential of one of the first electrode 9 and the second electrode 11 fluctuates to just one of the positive and negative sides relative to the potential of the other, charges moving in the direction from the first electrode 9 side to the second electrode 11 side are either positive or negative.

When a DC voltage is supplied to the third electrode 13 by the DC power supply device 17, an electric field is formed around the third electrode 13. In other words, an electric field is formed in the downstream region of the ion wind induced by the first electrode 9 and second electrode 11.

Accordingly, by attracting electrons or ions contained in the ion wind to the third electrode 13 side, the ion wind can be accelerated. That is, negative charges are attracted toward the third electrode 13 when a positive potential is given to the third electrode 13, while positive charges are attracted to the third electrode 13 when a negative potential is given to the third electrode 13.

Note that, both positive and negative charges exist in the downstream region of the ion wind. Accordingly, the third electrode 13 can attract negative or positive charges and accelerate the ion wind even if either a positive or negative DC voltage is supplied.

For example, when a positive DC voltage is supplied to the third electrode 13, attraction is generated between electrons forming plasma (negative charges) and the third electrode 13, and repulsion is generated between ions forming plasma (ions of positive charges formed by ionization of electrons from nitrogen or oxygen) and the third electrode 13.

In this case, the distance of movement of electrons due to the attraction between the third electrode 13 and electrons is longer than the distance of movement of ions due to the repulsion between the third electrode 13 and ions. In other words, the length of promotion of acceleration of the ion wind to the downstream side is longer than the length of restriction of the acceleration. Further, by the attraction described above, a range where the plasma (electrons in this case) exists can be made broader toward the third electrode 13 side. By the amount of this spread of plasma, the probability of kinetic energy being given to molecules in the air on their periphery rises. Accordingly, the ion wind can be effectively accelerated by suppressing the influence by the repulsion. Note that, when a negative DC voltage is applied to the third electrode 13, this situation becomes reverse to that described above. The ion wind can be accelerated by the attraction between the third electrode 13 and ions.

Note that, when the potential of one of the first electrode 9 and the second electrode 11 fluctuates to only one of positive or negative relative to the potential of the other, in other words, when the direction of the electric field formed by the first electrode 9 and second electrode 11 is constant, preferably the positive/negative of the DC voltage supplied to the third electrode 13 is set so that an electric field in the same direction as that of the former electric field is formed by the third electrode 13.

The electric field formed in the downstream region of the ion wind will be considered in more detail. Between the first electrode 9 and the third electrode 13, due to a potential difference between the first electrode 9 and the third electrode 13, as indicated by an arrow y5, an electric field having the direction between these electrodes as the orientation of the electric field is formed. The intensity of this electric field can be generally represented by dividing the potential difference between the two electrodes by the distance L between the two electrodes. Since the potential of the first electrode 9 fluctuates, the intensity of the electric field formed by the first electrode 9 and third electrode 13 fluctuates as well.

For example, as exemplified in FIG. 2, in a case where an AC voltage of −V1 to V1 is supplied to the first electrode 9 and a DC voltage of −V2 is supplied to the third electrode 13, intensities Ea, Eb, and EC of electric fields at the Pa point, Pb point, and Pc point in FIG. 2 are represented as follows where the orientation of the arrow y5 is the positive orientation of the electric field.

Pa point:Ea=(V1−(−V2))/L=(V1+V2)/L

Pb point:Eb=0−(−V2)/L=V2/L

Pc point:Ec=(−V1−(−V2))/L=(−V14+V2)/2

As will be understood from the above thinking, the greater the absolute value V2 of the DC voltage supplied to the third electrode 13, the stronger the electric field and the greater the action of accelerating the ion wind. Further, if the absolute value V2 of the DC voltage is greater than the maximum absolute value V1 of the AC voltage, the orientation of the electric field is constant irrespective of fluctuation of the AC voltage, so stabilization of the behavior of the ion wind can be expected.

Further, the shorter the distance L between the first electrode 9 and the third electrode 13, the stronger the electric field, and the greater the maximum speed of the ion wind. Conversely, as the distance L is longer, the ion wind can be accelerated over a longer distance. Note that, the work itself by the electric field is defined by the potential difference, so it is thought that the dependency upon the distance L is low.

According to the above first embodiment, the ion wind generator 3 has the first electrode 9 and the second electrode 11 which are supplied with voltage and induce the ion wind by electric discharge, and the field forming member (third electrode 13) which forms an electric field which accelerates the ion wind in the downstream region of the ion wind relative to the first electrode 9 and the second electrode 11.

Accordingly, the speed of the ion wind at the downstream can be raised. Further, the downstream region of the ion wind can be made longer as well. The effects such as improvement of speed or the like can be obtained without a special configuration of the first electrode 9 and second electrode 11 or increase of the voltage supplied to them. That is, it is easy to combine this invention with various technical ideas according to conventional ion wind generators, and it is easy to execute the invention of the present application by improvement of already existing products as well.

A field forming member for forming an electric field in the downstream region of the ion wind is the third electrode 13 which is arranged on the downstream side of the ion wind relative to the first electrode 9 and the second electrode 11 and is supplied with a DC voltage in a state where a closed loop is not configured.

Accordingly, an electric field can be formed in the downstream region of the ion wind by a convenient method of addition of an electrode. Further, the third electrode 13 does not configure a closed loop, therefore the power consumed in the third electrode 13 is only the power of electricity which flows by electrons or ions in the ion wind incident upon the third electrode 13, so the consumed amount of energy is a small. That is, the ion wind can be accelerated with a small consumed power.

The ion wind generator 3 further has a dielectric 7 which separates the first electrode 9 and the second electrode 11. The first electrode 9, second electrode 11, and third electrode 13 are disposed on the dielectric 7.

Accordingly, a simple, easy-to-produce configuration which just arranges electrodes on the dielectric 7 for performing dielectric barrier discharge can be used to generate ion wind having a fast speed.

The dielectric 7 is formed in a plate-shape. The first electrode 9 is a layer-state electrode which is parallel to (laminated on) the first major surface 7a of the dielectric 7. The second electrode 11 is a layer-state electrode which is parallel to the first major surface 7a (laminated on the second major surface 7b of the dielectric 7) and has a portion located nearer one side in the direction along the first major surface 7a (positive side in the x-direction) than the first electrode 9. The third electrode 13 is a layer-state electrode parallel to (laminated on) the first major surface 7a and is arranged nearer the above one side (positive side in the x-direction) than the second electrode 11.

Accordingly, the ion wind generator 3 can be formed by using a known common manufacturing technique for forming an electrode on a substrate (including a multilayer board), therefore a significant cost reduction is expected. Further, when the third electrode 13 is laminated on the first major surface 7a, it is arranged right in the downstream region of the ion wind which flows along the first major surface 7a, so the ion wind can be effectively accelerated and forms a substantially flat plane together with the first major surface 7a, so the third electrode 13 is also kept from forming a resistance against the ion wind.

Further, the ion wind generating apparatus 1 of the present embodiment has the AC power supply device 15 which supplies voltage to the first electrode 9 and second electrode 11 and makes the first electrode 9 and second electrode 11 generate ion wind by electric discharge and has the field forming parts (third electrode 13 and DC power supply device 17) for forming an electric field which accelerates the ion wind in the downstream region of the ion wind relative to the first electrode 9 and the second electrode 11. Accordingly, it exhibits the same effects as the effects exhibited by the ion wind generator 3 described above.

Further, an ion wind generating method of the present embodiment has a step of supplying voltage to the first electrode 9 and the second electrode 11 and inducing an ion wind by electric discharge and a step of forming an electric field in the downstream region of the ion wind relative to the first electrode 9 and the second electrode 11 and accelerating the ion wind. Accordingly, it exhibits the same effects as the effects exhibited by the ion wind generator 3 described above.

### Second Embodiment

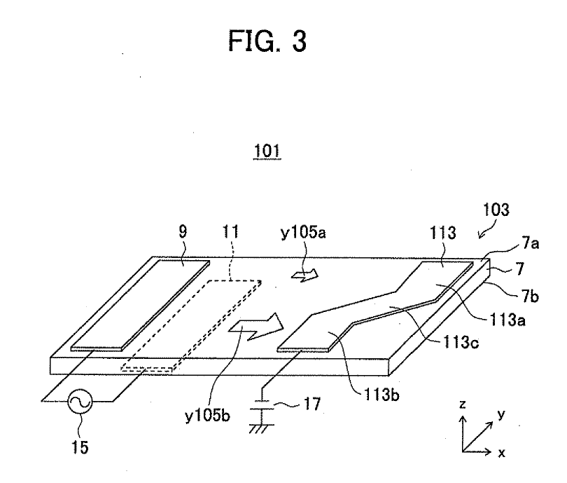

FIG. 3 is a perspective view schematically showing principal parts of an ion wind generating apparatus 101 of a second embodiment.

The ion wind generating apparatus 101 differs from the ion wind generating apparatus 1 of the first embodiment in only the shape of the third electrode. Specifically, this is as follows.

A third electrode 113 of an ion wind generator 103 is configured in a shape such that the distance from the first electrode 9 changes. For example, the third electrode 113 has a long distance part 113a, a short distance part 113b having a shorter distance from the first electrode 9 than the long distance part 113a, and an intermediate part 113c connecting the long distance part 113a and the short distance part 113b. Note that, the sizes of these in the flow direction (x-direction) of the ion wind are substantially constant.

In the same way as the first embodiment, the shorter the distance between the first electrode 9 and the third electrode 13, the stronger the electric field between the first electrode 9 and the third electrode 113. Accordingly, as indicated by an arrow y105a and an arrow y105b, the electric field between the first electrode 9 and the short distance part 113b becomes stronger than the electric field between the first electrode 9 and the long distance part 113a. As a result, in the ion wind, on the upstream side relative to the short distance part 113b, the side by the short distance part 113b is accelerated more than the side by the long distance part 113a.

As described above, according to the second embodiment, the third electrode 113 is configured in a shape such that the distance from the first electrode 9 changes, therefore a difference in intensity can be given to the ion wind in the width direction (y-direction) of the ion wind.

### Third Embodiment

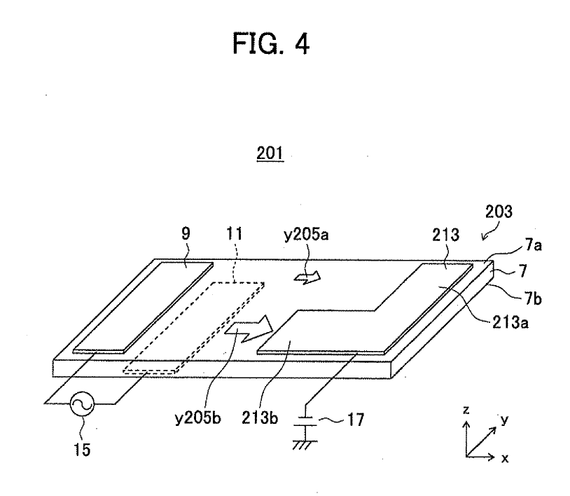

FIG. 4 is a perspective view schematically showing principal parts of an ion wind generating apparatus 201 of a third embodiment.

The ion wind generating apparatus 201 differs from the ion wind generating apparatus 1 of the first embodiment in only the shape of the third electrode. Specifically, this is as follows.

A third electrode 213 of an ion wind generator 203 is configured in a shape such that the size changes in the flow direction of the ion wind (x-direction). For example, the third electrode 213 has a small width section 213a and a large width section 213b which is larger than the small width section 213a in the x-direction.

The third electrode 213 changes in the distance from the first electrode 9 by due to the change in the size in the x-direction. Accordingly, in the same way as the second embodiment, as indicated by an arrow y205a and an arrow y205b, the electric field between the first electrode 9 and the large width section 213b becomes stronger than the electric field between the first electrode 9 and the small width section 213a. As a result, in the ion wind, on the upstream side relative to the large width section 213b, the large width section 213b side is accelerated more than the small width section 213a side.

As described above, according to the third embodiment, in the same way as the second embodiment, a difference in intensity can be given to the ion wind in the width direction (y-direction) of the ion wind.

### Fourth Embodiment

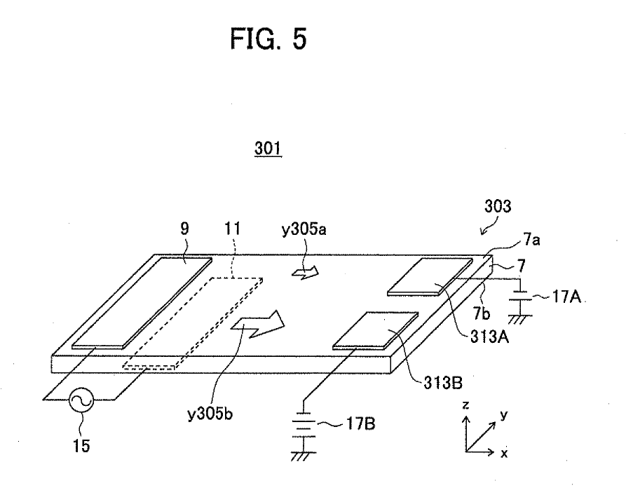

FIG. 5 is a perspective view schematically showing principal parts of an ion wind generating apparatus 301 of a fourth embodiment.

The ion wind generating apparatus 301 differs from the ion wind generating apparatus 1 of the first embodiment in only the configurations of the third electrode and the DC power supply device. Specifically, this is as follows.

An ion wind generator 303 has a plurality of (two are exemplified in the present embodiment) third electrodes 313A and 313B (hereinafter, sometimes A and B will be omitted) per set of first electrode 9 and second electrode 11. The two third electrodes 313 have for example shapes obtained by dividing the third electrode 13 in the first embodiment in the width direction (y-direction) of the ion wind. They are formed in rectangular shapes and have equivalent distances from the first electrode 9.

Further, the drive part (notation is omitted) of the ion wind generating apparatus 301 has a plurality of (two in the present embodiment) DC power supply devices 17A and 17B (hereinafter, sometimes A and B will be omitted) so that voltages can be individually supplied to a plurality of third electrodes 313. Note that, the plurality of DC power supply devices 17 may be grasped as one power supply device capable of individually supplying voltages to the plurality of third electrodes 313 as well.

The ion wind generating apparatus 301 can supply voltages which are different in magnitude from each other to the plurality of third electrodes 313 by the plurality of power supply devices 17. For example, the control device 19 (FIG. 1) individually controls the magnitudes of the supplied voltages of the plurality of DC power supply devices 17. Otherwise, the control device 19 controls only the ON/OFF state of the plurality of DC power supply devices 17 so that voltages which are different from each other due to the difference of configuration of the plurality of DC power supply devices 17 are supplied.

In the same way as the first embodiment, the larger the supplied voltage, the stronger the electric field between the first electrode 9 and the third electrodes 313. Accordingly, as exemplified in FIG. 5, in a case where the voltage applied to the third electrode 313B is greater than the voltage applied to the third electrode 313A, as indicated by an arrow y305a and an arrow 305b, the electric field between the first electrode 9 and the third electrode 3133 becomes stronger than the electric field between the first electrode 9 and the third electrode 313A. As a result, in the ion wind, the third electrode 313E side is accelerated more than the third electrode 313A side.

As described above, according to the fourth embodiment, the plurality of third electrodes 313 are disposed in a direction crossing the ion wind relative to the pair of the first electrode 9 and second electrode 11, and the plurality of DC power supply devices 17 can supply DC voltages having magnitudes different from each other to the plurality of third electrodes 313, therefore a difference in intensity can be given to the ion wind in the width direction (y-direction) of the ion wind.

### Fifth Embodiment

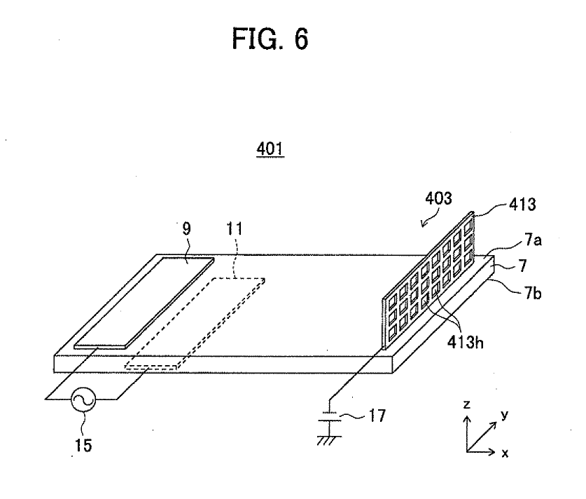

FIG. 6 is a perspective view schematically showing principal parts of an ion wind generating apparatus 401 of a fifth embodiment.

The ion wind generating apparatus 401 differs from the ion wind generating apparatus 1 of the first embodiment in only the shape of the third electrode. That is, in a third electrode 413 of an ion wind generator 403, a plurality of hole portions 413h through which the ion wind passes are formed. Specifically, this is as follows.

The third electrode 413 is formed in a general flat plate shape as a whole, is provided so as to stand up from the first major surface 7a, and faces the first electrode 9 and the second electrode 11 side. The planar shape of the third electrode 413 and its angle relative to the first major surface 7a may be suitably set. However, for example, the third electrode 413 is formed in a rectangular shape and is set up so as to be perpendicular to the first major surface 7a.

The plurality of hole portions 413h penetrate through the third electrode 413a in a direction from the first electrode 9 and second electrode 11 side to the third electrode 413 side. The shapes, sizes, number, arrangement method, etc. of the plurality of hole portions 413h may be suitably set. FIG. 6 exemplifies a case where the plurality of hole portions 413h are two-dimensionally arranged in the width direction (y-direction) and height direction (z-direction) of the ion wind, and the third electrode 413 is formed as a mesh-shaped (net-shaped) electrode.

Note that, the plurality of hole portions 413h in the mesh-shaped electrode may be arranged along the y-direction and z-direction as exemplified in FIG. 6, may be arranged along a diagonal direction of the rectangular third electrode 413, or may be irregularly distributed. Further, the sizes and shapes of the plurality of hole portions 413h may be the same as each other or may be different from each other. The density of distribution of the plurality of hole portions 413h may be even or may be uneven.

Such a third electrode 413 may be formed by for example forming holes in a metal sheet. The holes may be formed by for example punching or etching. Further, for example, the third electrode 413 may be formed by braiding a plurality of metal wires in a lattice or other suitable shape and joining them.

Note that, there is no particular restriction on the material for forming the third electrode 413. For example, stainless steel, an iron-nickel-cobalt alloy, aluminum, gold, silver, copper, or other metal material may be suitably selected.

The third electrode 413 may be fastened to the dielectric 7 by for example forming a groove in the dielectric 7 and fitting the third electrode 413 in that groove. Further, for example, it may be provided by using an organic resin-based binder or glass or metal to join the third electrode 413 to the dielectric 7. Note that, when a metal is used to join (solder) the third electrode 413 to the dielectric 7, preferably a brazing-use metal layer is disposed in advance on the first major surface 7a of the dielectric 7 by the metallization method etc.

According to the fifth embodiment, the hole portions 413h through which the ion wind passes are formed in the third electrode 413, therefore the range of forming the electric field can be spread in directions intersecting the ion wind (y-direction and z-direction) while suppressing an increase of resistance against the ion wind. As a result, the ion wind can be accelerated over a broad range.

In particular, since the third electrode 413 is a mesh-shaped electrode intersecting the ion wind, the ion wind can be accelerated while suppressing an increase of resistance against the ion wind over a broad range intersecting the ion wind. Further, by making the sizes and densities of the plurality of hole portions 413h even, the intensity of the ion wind is kept even. Conversely, by setting a bias in sizes or densities of the plurality of hole portions 413h, a difference in intensity can be given to the ion wind.

### Sixth Embodiment

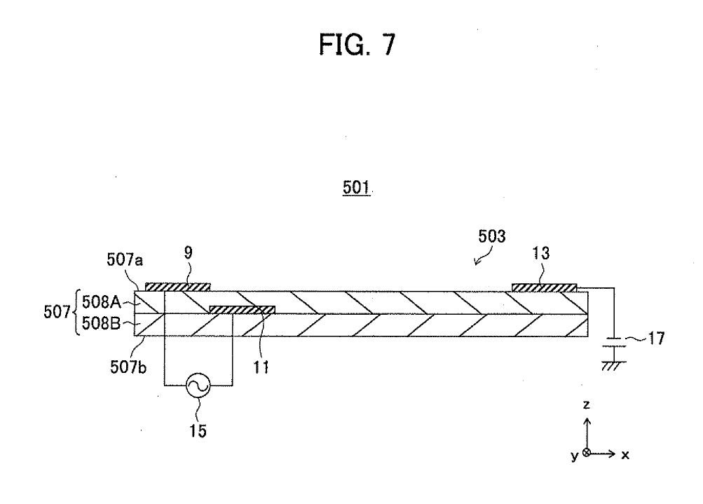

FIG. 7 is a perspective view schematically showing principal parts of an ion wind generating apparatus 501 of a sixth embodiment.

The ion wind generating apparatus 501 differs from the ion wind generating apparatus 1 in the first embodiment in only the point that at least one of the first to third electrodes is buried in the dielectric. In the present embodiment, a case where the second electrode 11 is buried is exemplified. Specifically, this is as follows.

A dielectric 507 of an ion wind generator 503 has a plurality of (two are exemplified in the present embodiment) first dielectric layer 508A and second dielectric layer 508B (hereinafter, sometimes simply referred to as “dielectric layers 508”) which are laminated on each other. That is, the dielectric 507 is configured by a laminate of a plurality of dielectric layers 508. The plurality of dielectric layers 508 are formed in for example rectangular flat plate shapes and are formed to have the same sizes and shapes as each other.

The first dielectric layer 508A configures a first major surface 507a of the dielectric 507. The second dielectric layer 508A configures a second major surface 507b of the dielectric 507. The first electrode 9 and third electrode 13 are arranged on the first major surface 507a in the same way as the first embodiment. On the other hand, the second electrode 11 is arranged between the first dielectric layer 508A and the second dielectric layer 508B and is buried in the dielectric 507 due to this.

This type of dielectric 507 is formed by for example laminating dielectric layers 508 configured by ceramic green sheets or the like and firing them. The conductors such as the first to third electrodes or the like are formed and fastened on the dielectric 507 by for example arranging conductive pastes on the pre-fired dielectric layers 508, and then firing them together with the laminated dielectric layers 508.

According to the above sixth embodiment, the same effects as those by the first embodiment are obtained. Further, the second electrode 11 is buried in the dielectric 507, therefore peeling from the dielectric 507 is suppressed and deterioration due to the gas flow etc. is suppressed. Further, the electrodes can be easily buried because the dielectric 507 is configured by the laminate of the plurality of dielectric layers 508.

### Seventh Embodiment

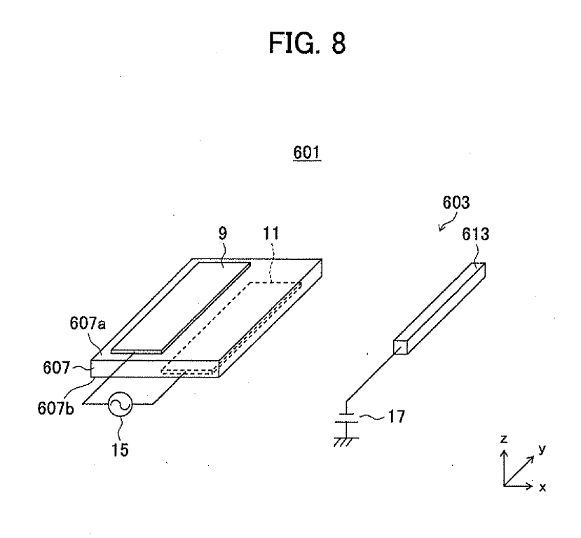

FIG. 8 is a perspective view schematically showing principal parts of an ion wind generating apparatus 601 of a seventh embodiment.

The ion wind generating apparatus 601 differs from the ion wind generating apparatus 1 in the first embodiment in the point that a third electrode 613 is not disposed on a dielectric 607. Specifically, this is as follows.

The dielectric 607 is given a size and shape large enough for arrangement of the first electrode 9 and second electrode 11. For example, the dielectric 607 is given a shape so that a portion in the dielectric 7 in the first embodiment which is located on the third electrode 13 side is cut off. Note that, this embodiment is the same as the first embodiment in the point that the first electrode 9 is arranged on a first major surface 607a, and the second electrode 11 is arranged on a second major surface 607b.

The third electrode 613 is supported by a not shown support member. The support member may be fixed to the dielectric 607 or may be connected to the dielectric 607 moveable relative to the dielectric 607. When the support member can move, the movement may be manually carried out or may be carried out by power from a drive source such as a motor or the like.

Note that, so far as the third electrode 613 is moveable in the x-direction relative to the dielectric 607, the distance between the first electrode 9 and the third electrode 613 changes, therefore the wind speed can be changed by changing the intensity of the electric field. Further, if the third electrode 613 can move in the y-direction or z-direction relative to the dielectric 607, the direction of accelerating the ion wind can be changed.

The shape of the third electrode 613 may be a suitable shape. FIG. 8 exemplifies a case where the third electrode 613 is formed in a rod shape having a rectangular cross-section and extending in the width direction (y-direction) of the ion wind.

According to the above seventh embodiment, in the same way as the first embodiment, the effect of raising the wind speed by accelerating the ion wind is obtained. Further, the third electrode 613 is not provided on the dielectric 7, therefore the degree of freedom of design is high and accordingly the acceleration of the ion wind can be suitably adjusted. There is no dielectric interposed between the first electrode 9 and the third electrode 613, therefore the dielectric constant becomes low and the fall of the intensity of the electric field formed by the third electrode 613 is suppressed.

### Eighth Embodiment

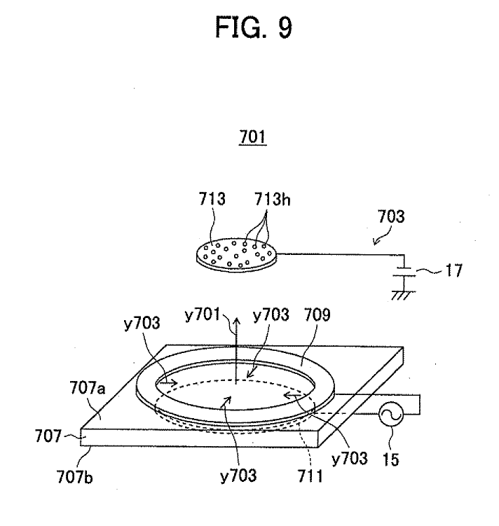

FIG. 9 is a perspective view schematically showing principal parts of an ion wind generating apparatus 701 of an eighth embodiment.

In an ion wind generator 703, a first electrode 709 is formed in a ring-shape and is arranged on a first major surface 707a of a dielectric 707. Further, a second electrode 711 is formed circularly so as to be contained inside the inner edge of the first electrode 709 and is arranged on a second major surface 707b of the dielectric 707.

When applying AC voltage to such a first electrode 709 and second electrode 711, as indicated by arrows y703, streams of ion wind which flow to the center side of the first electrode 709 are induced. Then, the streams of ion wind which flow to the center side from various directions strike each other and flow to the direction that the first major surface 707a faces as indicated by an arrow y701.

Further, the third electrode 713 is arranged in the downstream region of the ion wind which flows to the direction that the first major surface 707a faces and accelerates the ion wind in the same way as in the other embodiments. Note that, the third electrode 713 may be given a suitable shape. FIG. 9 exemplifies a case where the third electrode 713 is a disk-shaped mesh electrode in which a plurality of hole portions 713h are formed.

According to the above eighth embodiment, in the same way as the first embodiment, the effect of accelerating the ion wind to raise the wind speed is obtained.

### Ninth Embodiment

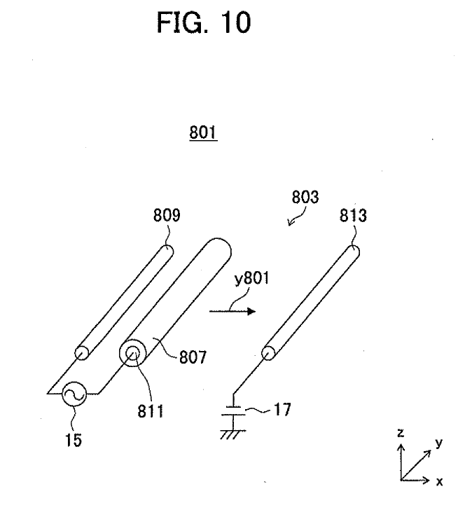

FIG. 10 is a perspective view schematically showing principal parts of an ion wind generating apparatus 801 of a ninth embodiment.

In an ion wind generator 803, a dielectric 807 covers a second electrode 811. A first electrode 809, second electrode 811, and third electrode 813 are arranged in that order along the direction of flow of the ion wind indicated by an arrow y801. Note that, these electrodes are fixed to each other or connected moveable relative to each other by not shown suitable support members.

The first electrode 809, second electrode 811, and third electrode 813 may be given suitable shapes. FIG. 10 exemplifies a case where all of the electrodes are formed in rod-shape each having a circular cross-section.

In such an ion wind generator 803, when AC voltage is supplied to the first electrode 809 and second electrode 811, an ion wind which flows from the first electrode 809 side to the second electrode 811 side is induced. This ion wind flows along the surface of the dielectric 807 and passes over the dielectric 807. Then, the ion wind is accelerated by the third electrode 813 to which a DC voltage is supplied.

As explained above, according to the ninth embodiment, in the same way as the first embodiment, the effect of accelerating the ion wind to raise the wind speed is obtained.

Note that, in the above embodiments, the third electrodes 13, 113, 213, 313, 413, 613, 713, and 813 are examples of the field forming member of the present invention, combinations of these third electrodes with the DC power supply device 17 are examples of the field forming part of the present invention, the AC power supply device 15 is an example of the first power supply of the present invention, and the DC power supply device 17 (or plurality of DC power supply devices 17) is an example of the second power supply of the present invention.

The present invention is not limited to the above embodiments and may be executed in various ways.

The electric discharge for inducing the ion wind is not limited to a dielectric barrier discharge. For example, it may be a corona discharge as well. In other words, the dielectric is not an essential factor of the present invention.

The voltage supplied to the first electrode and second electrode is not limited to AC voltage and may be DC voltage as well. Note, when a dielectric barrier discharge is carried out, preferably an AC voltage by which the potential of one of the first electrode and the second electrode fluctuates to both of the positive and negative relative to the potential of the other is supplied so that discharge will be continuously carried out.

In a case where a dielectric is disposed for a dielectric barrier discharge, as exemplified in the seventh to ninth embodiments (FIG. 8 to FIG. 10), at least one of the first to third electrodes need not be disposed on the dielectric (need not be adhered). The dielectric has only to separate the first electrode and the second electrode.

The dielectric is not limited to one of a flat plate shape. For example, as exemplified in the ninth embodiment (FIG. 10), it may be one covering the electrode. Further, the plate-shaped dielectric is not limited to one having a surface which is a flat plane and may be one having a surface which is a curved surface as well. For example, when an ion wind generator is disposed on a wing in order to suppress peeling of the boundary layer in the wing, preferably the surface of the dielectric is a curved surface continuing from the surface of the wing.

The electrode is not limited to one arranged on the surface of the dielectric or buried in the dielectric. For example, the electrode may be arranged so as to be engaged with a concave portion formed in the dielectric so that only the major surface of the electrode is exposed from the dielectric. In this case, the resistance of the ion wind due to the electrode is reduced. Further, for example, only one portion in the first electrode which is located on the second electrode side may be exposed from the dielectric as well. In this case, the input/output of charges in the first electrode can be preferably carried out while protecting the first electrode.

As shown in the sixth embodiment (FIG. 7), when at least one of the first to third electrodes is buried in the dielectric, the relative arrangements among the electrodes in the thickness direction of the dielectric may be suitably set. For example, all of the first to third electrodes may be buried in the same layer (at the same position in the thickness direction) or at least one electrode may be buried so that all of the first to third electrodes are arranged in layers which are different from each other.

The downstream region of the ion wind in which the electric field for acceleration is formed is not limited to the region on the side opposite to the first electrode relative to the second electrode or the region which is along the surface of the dielectric as exemplified in the eighth embodiment (FIG. 9). For example, in a case where the ion wind induced by the first electrode and second electrode passes through a tubular member and the wind direction is changed to a suitable direction due to bending of the tubular member, an electric field may be formed so as to accelerate the ion wind after that wind direction is changed. In the same way, the downstream side of the ion wind on which the third electrode is arranged is not limited to the side opposite to the first electrode relative to the second electrode.

As mentioned in the seventh embodiment (FIG. 8), the electric field is not limited to one performing only acceleration of the ion wind using the direction of flow of the ion wind as the orientation of the electric field. That is, the electric field may be one using a direction diagonally crossing the flow direction of the ion wind as the orientation of the electric field and performing not only acceleration, but also change or adjustment of the flow direction of the ion wind.

The third electrode does not have to have an equivalent size as those of the first and second electrodes in the width direction (y-direction) of the ion wind. For example, the third electrode may be present in only a portion in the width direction of the ion wind and accelerate only a portion of the ion wind. Conversely, the third electrode may be larger than the first and second electrodes.

The third electrode which changes in the distance from the first electrode as exemplified in the second and third embodiments (FIG. 3 and FIG. 4) is not limited to one changed in the distance in the width direction (y-direction) of the ion wind. For example, in the third electrode spread in the width direction (y-direction) and in the height direction (z-direction) of the ion wind as shown in the fifth embodiment (FIG. 6), the distance from the first electrode may change in accordance with the position in the z-direction in addition to the y-direction or in place of the y-direction.

Further, in the second and third embodiments (FIG. 3 and FIG. 4), third electrodes having extremely simple shapes were exemplified, but the shape of the third electrode may be suitably set. For example, the third electrode may be given a shape extending in the width direction (y-direction) of the ion wind in a zigzag or wave form or may be formed in a triangle or circle. Further, a plurality of such third electrodes having various shapes may be arranged in the y-direction or the height direction (z-direction) of the ion wind while making their positions in the flow direction α-direction) of the ion wind the same or making their positions in the x-direction different from each other relative to the set of first electrode and second electrode. To the plurality of third electrodes arranged in this way, voltages the same as each other may be supplied or voltages different from each other may be supplied as exemplified in the fourth embodiment (FIG. 5). By combination of various shapes, arrangements, and voltages according to the third electrode as described above, more preferably a difference in intensity can be given to the ion wind and occurrence of turbulence can be facilitated.

The plurality of third electrodes are not limited to ones which are arranged while making their positions in the y-direction and/or z-direction different from each other for the purpose of giving a difference in intensity to the ion wind in the width direction (y-direction) and/or height direction (z-direction) of the ion wind. For example, the third electrodes may be arranged along the flow direction α-direction) of the ion wind while making their positions in the y-direction and z-direction the same. In this case, for example, by supplying DC voltage so that the potential becomes higher toward the lower current side, the ion wind can be accelerated over a long distance evenly or unevenly.

Further, as exemplified in the fourth embodiment (FIG. 5), in the case where voltages which are different from each other are supplied to the plurality of third electrodes, it is not necessary to enable individual application of voltages in all third electrodes. That is, some electrodes among the plurality of third electrodes may be connected in parallel or series.

As exemplified in the fifth embodiment (FIG. 6), when hole portions penetrating in the direction from the first electrode and second electrode to the third electrode are formed in the third electrode, the number of hole portions is not limited to a plurality of portions and may be one as well, For example, the third electrode may be a ring-shape. Further, the electrode having the hole portions formed therein is not limited to a plate-shaped one, and the plurality of hole portions do not have to be two-dimensionally arranged. For example, in a rod-shaped third electrode extending in the width direction (y-direction) of the ions, a plurality of hole portions arranged in a line along the y-direction may be formed as well.

### REFERENCE SIGNS LIST

1 . . . ion wind generating apparatus, 3 . . . ion wind generator, 9 . . . first electrode, 11 . . . second electrode, 13 . . . third electrode (field forming member, electric field forming part), and 17 . . . DC power supply device (first power supply, field forming part).

1-13. (canceled)

14. An ion wind generator comprising:
a first electrode and a second electrode which are supplied with voltage and induce an ion wind by electric discharge and
a field forming member which forms an electric field for accelerating the ion wind in a downstream region of the ion wind relative to the first electrode and the second electrode.

15. The ion wind generator as set forth in claim 14, wherein the field forming member is a third electrode which is arranged on a downstream side of the ion wind relative to the first electrode and the second electrode and to which a DC voltage is supplied in a state where a closed loop is not formed.

16. The ion wind generator as set forth in claim 15, further comprising:
a dielectric separating the first electrode and the second electrode, wherein
the first electrode, the second electrode, and the third electrode are disposed on the dielectric.

17. The ion wind generator as set forth in claim 16, wherein
the dielectric is formed in a plate-shape,
the first electrode is a layer-shaped electrode parallel to a predetermined major surface of the dielectric,
the second electrode is a layer-shaped electrode parallel to the predetermined major surface and has a portion which is located nearer one side in the direction along the predetermined major surface than the first electrode, and
the third electrode is a layer-shaped electrode parallel to the predetermined major surface and is arranged nearer the one side than the second electrode.

18. The ion wind generator as set forth in claim 15, wherein a hole portion through which the ion wind passes is formed in the third electrode.

19. The ion wind generator as set forth in claim 16, wherein a hole portion through which the ion wind passes is formed in the third electrode.

20. The ion wind generator as set forth in claim 18, wherein the third electrode is a mesh-shaped electrode which intersects the flow direction of the ion wind.

21. The ion wind generator as set forth in claim 15, wherein the third electrode is given shape such that the distance from the first electrode changes.

22. The ion wind generator as set forth in claim 16, wherein the third electrode is given shape such that the distance from the first electrode changes.

23. The ion wind generator as set forth in claim 17, wherein the third electrode is given shape such that the distance from the first electrode changes.

24. The ion wind generator as set forth in claim 15, wherein a plurality of third electrodes are disposed per pair of the first electrode and the second electrode.

25. The ion wind generator as set forth in claim 16, wherein a plurality of third electrodes are disposed per pair of the first electrode and the second electrode.

26. The ion wind generator as set forth in claim 17, wherein a plurality of third electrodes are disposed per pair of the first electrode and the second electrode.

27. An ion wind generating apparatus comprising:
a first electrode,
a second electrode,
a first power supply which supplies voltage to the first electrode and the second electrode and makes the first electrode and the second electrode induce an ion wind by electric discharge, and
a field forming part which forms an electric field for accelerating the ion wind in the downstream region of the ion wind relative to the first electrode and the second electrode.

28. The ion wind generating apparatus as set forth in claim 27, wherein the field forming part has
a third electrode which is arranged on the downstream side of the ion wind relative to the first electrode and the second electrode and
a second power supply which supplies a DC voltage to the third electrode in a state where a closed loop is not formed.

29. The ion wind generating apparatus as set forth in claim 28, wherein:
the first power supply supplies AC voltage to the first electrode and the second electrode, and
an absolute value of the voltage supplied by the second power supply is larger than a maximum absolute value of the voltage supplied by the first power supply.

30. The ion wind generating apparatus as set forth in claim 28, wherein:
a plurality of third electrodes are disposed per pair of the first electrode and the second electrode, and
the second power supply can supply DC voltages having magnitudes different from each other to the plurality of third electrodes.

31. An ion wind generating method comprising:
a step of supplying voltage to a first electrode and a second electrode and inducing an ion wind by electric discharge and
a step of forming an electric field in the downstream region of the ion wind relative to the first electrode and the second electrode and accelerating the ion wind.
